(19) United States
(12) Patent Application Publication
(10) Pub. No.: US 2019/0193445 A1
(43) Pub. Date: Jun. 27, 2019

(54) Method For Creating A Mark With A Desired Colour On An Article

(71) Applicant: SPI Lasers UK Limited, Hedge End, Southampton (GB)

(72) Inventors: Paul Martin HARRISON, Salisbury (GB); Adam Piotr Rosowski, Southampton (GB)

(21) Appl. No.: 16/301,336

(22) PCT Filed: May 18, 2017
(86) PCT No.: PCT/GB2017/000078

§ 371 Date: Nov. 13, 2018

(30) Foreign Application Priority Data
May 20, 2016 (GB) 1609086.2

(51) Int. Cl. B41M 5/26; B41M 5/24

(52) U.S. Cl. CPC B41M 5/262; B41M 5/24

(57) ABSTRACT

A method for creating a mark (16) with a desired colour on an article (40), wherein the article (40) comprises a metal (44) having a metal surface (5), and which method comprises: providing a laser (1) for emitting a laser beam (4) comprising laser pulses (21) having a pulse energy (25), a pulse width (26), a pulse repetition frequency (27), and a wavelength (20); providing a scanner (2), which comprises a first mirror (6) for scanning the laser beam (4) in a first direction (8), and a second mirror (7) for scanning the laser beam (4) in a second direction (9); providing a lens (3) for focussing the laser beam (4) from the laser (1) onto the metal surface (5) to form a spot (31) having a spot diameter (34) and a pulse fluence (36); providing a controller (11) for controlling the scanner (2) with a control signal ( 12); marking a plurality of lines (15) separated by a hatch distance (19) on the metal surface (5) to form the mark (16) by scanning the scanner (2) with a scan speed (17) while pulsing the laser (1); and selecting the scan speed (17), the pulse repetition frequency (27), and the spot diameter (34) to provide a desired spot to spot separation (18) between the centres (37) of consecutive spots (31) during each scan of the scanner (2), the method being characterized by: causing the article (40) to be such that it has had a mark-facilitating layer (102) applied to the metal surface (5), which mark-facilitating layer (5) allows the laser pulses (21) to pass through the mark-facilitating layer (102) and strike the metal surface (5); selecting the pulse fluence (36) to cause a plume (41) comprising material (45) from the metal surface (5) to be ejected from the metal surface (5); retaining at least a portion of the plume (41) with the mark-facilitating layer (102) in order to enable the plume (41) to mark the metal surface (5); the colour being given by the spot to spot separation (18), the hatch distance (19), the pulse fluence (36), the pulse width (26), and the number of times each line (15) is written; and selecting the spot to spot separation (18), the hatch distance (19), the pulse fluence (36), the pulse width (26), and the number of times each line (15) is written, to form the desired colour.

### FIELD OF INVENTION

This invention relates to a method for creating a mark with a desired colour on an article. The invention has particular application for rapidly marking articles having metal surfaces with high quality black marks without the use of dyes, inks or other chemicals. The invention also has application for making black marks on silver, gold and other precious metals used in the jewellery industry.

### BACKGROUND TO THE INVENTION

The use of dyes, inks and other chemicals in the marking of commercial, consumer and industrial goods places restrictions on supply chains, logistics and the environment. Processes that can mark without the use of dyes, inks or other chemicals can therefore provide a distinct advantage. Laser marking is also generally more versatile, reproducible, and can provide marks that have a higher quality and durability than chemical methods such as silk screens.

Laser marking has been applied to many materials including metals. It is very desirable and commercially very important in consumer goods to have a mark that is distinctive in shape, quality and colour, and that has a high colour contrast to the surrounding material. Once perfected for a particular material, the laser marking process is typically reliable, repeatable, and amenable to high-throughput high-yield production.

Laser marking of anodized metals is known, and is used in the manufacture of many consumer electronics products. The anodized metals have an anodized layer which is formed using an electrolytic passivation process in which an oxide layer is grown on the metal surface. The anodizing may increase the resistance to corrosion and wear, and may provide better adhesion for paint and glue. However, the anodizing adds another processing step. Also, the anodizing is not necessary for metals that are already corrosion resistant, for example titanium. Further, anodizing cannot be applied to certain metals such as gold, silver, platinum and palladium.

U.S. Pat. No. 6,777,098 describes a method of marking anodized aluminium articles with black marks which occur in a layer between the anodization and the aluminium, and therefore are as durable as the anodized surface. The marks are obtained using nanosecond infrared laser pulses, and are described as being dark grey or black in hue and are somewhat less shiny than an unmarked portion of the anodized surface. As taught in U.S. Pat. No. 8,451,873, making marks according to the methods claimed in U.S. Pat. No. 6,777,098 are disadvantageous because (i) creating commercially desirable black marks with nanosecond range pulses tends to cause destruction of the oxide layer, and (ii) cleaning of the aluminium following polishing or other processing adds another step in the process, with associated expense, and possibly disturbs a desired surface finish.

U.S. Pat. No. 8,451,873 discloses a method for creating a mark on an anodized specimen. The method involves providing a laser marking system having controllable laser pulse parameters, determining the laser pulse parameters associated with the desired properties, and directing the laser marking system to mark the article using the selected laser pulse parameters. Laser marks so made have an optical density that ranges from transparent to opaque, a white colour, a texture indistinguishable from the surrounding article. The laser marks are durable and the anodization is substantially intact. The patent teaches that marks created using laser pulses greater than 1 nanosecond results in clear signs of cracking of the anodization. In particular, the patent teaches that when marking with prior art nanosecond pulses, applying enough laser pulse energy to the surface to make dark marks causes damage to the anodization which causes the appearance of the marks to change with viewing angle. The patent also teaches solving this problem by using pulses having pulse widths of approximately 10 ps. Marks produced by using pulses having pulse widths of approximately 10 ps or less do not damage the anodization, regardless of how dark the marks are, and nor do the marks change in appearance with viewing angle. Such marks are typical of so-called “cold processing” that utilizes multi-photon absorption effects in the material. Cold processing (such as cold ablation) does not rely on thermal effects to produce the desired processing effect, and therefore causes little if any thermal damage surrounding the processed area. Cold processing relies on femtosecond lasers, or picosecond lasers having pulse widths up to around 10 ps to 50 ps. The colour of the marks can be quantified by the International Commission on Illumination (CIE) system of colourimetry. In the CIE system, the darkest colour is black with a lightness L*=0, and the brightness white has a lightness L*=100. Neutral grey colours have the colour channels a*=b*=0. Negative values of a* indicate green, while positive values indicate magenta. Negative values of b* indicate blue, while positive values indicate yellow. The colour of the marks had a lightness L*=40, magenta/green opponent colour a*=5, and yellow/blue opponent colour b*=10. Although the picosecond lasers used in the patent were much less expensive than femtosecond lasers, the picosecond lasers users are more expensive than nanosecond lasers because they rely on very advanced techniques and components such as optical pulse compressors to produce the very narrow laser pulse widths. Moreover, an L* value lower than approximately 30 is more commercially important, and for this, the picosecond lasers used do not write the marks quickly enough for many commercial applications where cost is at a premium. It is advantageous not to rely on expensive techniques or components such as optical pulse compression and optical pulse compressors.

A method that can be used to laser mark an anodized metal surface with a nanosecond pulsed laser without damaging the anodization is described in WO 2015/082869. The method uses pulses with lower pulse fluence, and writes each line more than once. The colour is given by the spot to spot separation, the hatch distance, the pulse fluence, the pulse width, and the number of times each line is written. The method includes the step of selecting the spot to spot separation, the hatch distance, the pulse fluence, the pulse width, and the number of times each line is written to form the desired colour. However, the method is not applicable to laser marking of non-anodized metal surfaces such as aluminium, silver and gold. The method also does not provide sufficiently smooth and dark marks on polished metal surfaces used in jewellery and other products where the appearance of the mark is commercially important.

U.S. Pat. No. 8,451,873 discloses a method for laser marking a metal surface with a desired colour. The method comprises forming at least one first pattern on the metal surface with a first laser beam having a first pulse fluence, and then forming at least one second pattern on the metal surface with a second laser beam having a second pulse fluence, causing the second pattern to be positioned entirely within the first pattern, and arranging the first pulse fluence to be at least five times greater than the second pulse fluence. The colour is given by the first and second pulse fluences and spot spacings in the first and second patterns. The method can create marks on copper alloys such as bronze and brass having colours such as black, brown, tangerine, purple, light brown, grey, and orange. However the method roughens the surface of the copper alloy, and the method does not produce coloured marks on bare aluminium, copper, silver and gold surfaces.

Laser marking of non-anodized metal surfaces such as steel and bronze is known. However it has proven difficult to colour mark bare metals surfaces such as aluminium, copper, gold, silver, and other precious metals, without using chemical methods, such using as using a black oxidation solution.

There is a need for a method for creating a mark with a desired colour on an article that reduces or avoids the aforementioned problems.

### The Invention

Accordingly, in one non-limiting embodiment of the present invention there is provided a method for creating a mark with a desired colour on an article, wherein the article comprises a metal having a metal surface, and which method comprises:
providing a laser for emitting a laser beam comprising laser pulses having a pulse energy, a pulse width, a pulse repetition frequency, and a wavelength;
providing a scanner comprising a first mirror for scanning the laser beam in a first direction, and a second mirror for scanning the laser beam in a second direction;
providing a lens for focussing the laser beam from the laser onto the metal surface to form a spot having a spot diameter and a pulse fluence;
providing a controller for controlling the scanner with a control signal;
marking a plurality of lines separated by a hatch distance on the metal surface to form the mark by scanning the scanner while pulsing the laser; and
selecting a scan speed, the pulse repetition frequency, and the spot diameter to provide a desired spot to spot separation between the centres of consecutive spots during each scan of the scanner;

the method being characterized by:
causing the article to be such that it has had a mark-facilitating layer applied to the metal surface, which mark-facilitating layer allows the laser pulses to pass through the mark-facilitating layer and strike the metal surface;
selecting the pulse fluence to cause a plume comprising material from the metal surface to be ejected from the metal surface;
retaining at least a portion of the plume with the mark-facilitating layer in order to enable the plume to mark the metal surface;
the colour being given by the spot to spot separation, the hatch distance, the pulse fluence, the pulse width, and the number of times each line is written; and
selecting the spot to spot separation, the hatch distance, the pulse fluence, the pulse width, and the number of times each line is written to form the desired colour.

The method of the present invention is particularly attractive because it is able to produce marks on metal surfaces faster, and therefore more economically than has hitherto been possible without the need for anodization, consumable inks or chemicals. More importantly, it is able to produce marks on bare metal surfaces such as non-anodized aluminium and titanium, as well as silver, gold, platinum, palladium, and other precious metals that are important in jewellery manufacturing.

The spot to spot separation may be at least one tenth of the spot diameter. The spot to spot separation may be at least a quarter of the spot diameter. The spot to spot separation may be at least half the spot diameter. The spot to spot separation may be at most equal to the spot diameter.

The method of the present invention may be one in which the mark-facilitating layer is applied to the article during the above mentioned steps of creating the mark. Thus, for example, the mark-facilitating layer may be applied to the article before the steps of marking the plurality of lines separated by the hatch distance on the metal surface. Alternatively, the method of the present invention may be one in which the article is provided with the mark-facilitating layer prior to the commencement of the above mentioned steps of creating the mark. Thus for example, the article with the mark-facilitating layer could be bought from another manufacturer.

The step of applying the mark-facilitating layer to the metal surface may include one of pressing, squeezing, coating, painting, evaporating, sticking, winding, or stretching the mark-facilitating layer onto the surface, Preferably, the mark-facilitating layer is applied to the article, and is not a layer such as an anodized layer that is grown from material that originated in the article.

The mark-facilitating layer may be in contact with the metal surface. The mark-facilitating layer and the metal surface may be forced together in order to create a sufficient contact.

Prior art methods of marking bare metal surfaces are such that they mark the metal surface without the use of a mark-facilitating layer. In the prior art methods, the pulse fluence causes a plume comprising material from the metal surface to be ejected from the metal surface. The plume has a recoil pressure and comprises materials from the metal surface as well as gases that have been heated and rapidly expanded. Depending on the metal surface, this can result in marks that are either engraved into the metal surface, or are visible by virtue of a change in the surface texture of the metal surface. However, the prior art methods are disadvantageous in that marks having a different colour from the metal surface are not formed on bare metals such as aluminium, silver, or gold without the use of chemicals such as inks or dyes. Black marks are not able to be written onto copper. Coloured marks, including black marks, are not able to be written onto copper alloys such as bronze or brass without substantially roughening the surface. These disadvantages of the prior art methods are able to be overcome in the present invention due to the use of the mark facilitating layer.

More specifically, by placing the mark-facilitating layer in contact with the metal surface, the plume can be prevented from dissipating if the contact of the mark-facilitating layer with the metal surface is sufficient to retain at least a portion of the recoil pressure of the plume. The plume and the recoil pressure are then retained by the contact between the metal surface and the mark-facilitating layer, and material that would otherwise be dispersed is retained can form a mark on the metal surface. The recoil pressure causes material from the plume to mark the metal surface. Surprisingly, dark marks can be formed on metal surfaces for which dark marks cannot be produced without the mark-facilitating layer being in place, and moreover, it is possible to form marks that are smooth. Importantly, black marks can be written onto aluminium, copper, silver and gold. Black marks can also be written onto copper. Black marks can also be written onto copper alloys such as brass or bronze without roughening the surface. In the method of the invention, the pulse fluence may be increased if required in order to compensate for optical attenuation of the laser beam by the mark-facilitating layer.

In the method of the present invention, the plume may have a recoil pressure, and the mark-facilitating layer may have a contact with the metal surface, which contact is sufficient to retain at least a portion of the recoil pressure of the plume.

The method of the present invention may include the step of selecting the spot to spot separation, the hatch distance, the pulse fluence, the pulse width, and the number of times each line is written such that the mark has a surface roughness average Ra value less than or equal to fifty microns. The surface roughness average Ra value may be less than or equal to twenty microns. The surface roughness average Ra value may be less than or equal to five microns. The ability to produce marks, without the use of inks or chemicals, on bare metal surfaces that are smooth, is a particularly novel and surprising aspect of the method of the invention. The ability to produce marks without substantially degrading the smoothness of the bare metal surface is important in jewellery manufacture.

The metal surface may comprise a bare metal surface.

The metal surface may comprise an additional layer. For clarity, the additional layer is not the mark-facilitating layer. The additional layer may be a metallic coating. Electronic components are often coated with gold. The additional layer may comprise an oxide layer. Metals such as “bare aluminium” have a thin oxide layer on their surface.

The metal surface may comprise a non-anodized metal surface.

The metal surface may comprise copper, aluminium, gold, silver, platinum, palladium, nickel, titanium, tin, iron, chromium, stainless steel or an alloy containing one of the preceding metals such as bronze or brass.

The mark-facilitating layer may comprise glass.

The mark-facilitating layer may comprise sapphire.

The mark-facilitating layer may comprise a lacquer.

The mark-facilitating layer may comprise a conformal coating.

The mark-facilitating layer may comprise a sheet material. The sheet material may comprise a polymer. The sheet material may be an adhesive-backed tape.

The mark-facilitating layer may have a thickness greater than 1 μm. The thickness may be between 50 μm and 3 mm. The mark-facilitating layer can be flexible or rigid. The mark-facilitating layer can be a glass sheet, a plastic sheet such as polyethylene, a lacquer or any other mark-facilitating layer. The mark-facilitating layer may be an adhesive-backed tape. The adhesive-backed tape may comprise cellophane. The adhesive-backed tape may comprise a high temperature polymer. The high temperature polymer may comprise acrylic. The high temperature polymer may comprise silicone. The high temperature polymer may comprise polyimide. The high temperature polymer may comprise polyester. The high temperature polymer may be halogen free. Adhesive-backed tapes are particularly advantageous as they can be applied to the surface simply, and are easily removed after marking. The mark-facilitating layer may be in physical contact with the metal surface where the mark is to be made. The mark-facilitating layer may have enough rigidity to remain in contact with the metal during the marking process. The mark-facilitating layer may be supported by the metal surface. The mark-facilitating layer may be removed after processing or left in place.

The method may include the step of removing the mark-facilitating layer. The step of removing the mark-facilitating layer may comprise chemical processing. The chemical processing may be immersion in a solvent such as acetone. Acetone can dissolve lacquers.

The mark-facilitating layer may have an optical transmission at the wavelength of the laser beam of at least 50%. The optical transmission may be at least 80%. The optical transmission may be at least 90%.

The colour may be grey or black with an L* value no greater than 50. The L* value may be no greater than 30. A mark with an L* value no greater than 30 would generally be considered to be a black mark. Such marks are very attractive when written on silver and gold.

The laser may be a pulsed laser providing a laser beam having a pulse width greater than one hundred picoseconds. The pulse width may be greater than 1 nanosecond. It is highly significant that high quality black marks (L*<=30) can be made rapidly, and with nanosecond pulsed lasers as opposed to picosecond pulsed lasers. This is because nanosecond pulsed lasers are by their very nature lower cost than picosecond lasers, and are much lower cost than femtosecond and picosecond pulsed lasers that have pulse widths less than approximately 50 ps and are which marketed for cold laser processing applications such as cold ablation.

The wavelength may be in the range 1000 nm to 1100 nm. The laser may be a ytterbium-doped fibre laser. The fibre laser is preferably in the form of a master oscillator power amplifier with pulse shapes and pulse waveform parameters that can be optimized for the desired mark.

The scanner mirrors may be accelerated prior to pulsing the laser.

The metal surface may be orientated to minimize the overall time taken to form the mark.

The scanning speed may be at least 1 m/s. The scanning speed may be at least 5 m/s.

The pulse repetition frequency may be at least 100 kHz. The pulse repetition frequency may be at least 500 kHz.

The scanning speed may be at least 9 m/s, and the pulse repetition frequency may be at least 900 kHz. This combination of scanning speed and pulse repetition frequency is equivalent to a spot to spot separation of 10 μm. This is typically around half the diameter of the spot formed by the laser beam.

Each line may be written more than once. Preferably, each line is written at least 5 times, but more or less times may be employed. Although it is possible to scan each line only once with the same pulse repetition frequency, it has been found that thermal damage can occur on the metal surface. It is therefore preferred to write each line as rapidly as possible in order to minimize thermal damage and thus optimize the quality of the mark. The spacing between successive lines, referred to as the hatch distance, may be less than the spot diameter, preferably less than a tenth of the spot diameter or more preferably less than a hundredth of the spot diameter. The difference in angle between hatch lines of successive repeats may be in the range 1° to 359°. The mark-facilitating layer may be replaced between successive repeats.

The spot to spot separation may be at least a quarter of the spot diameter. The spot to spot separation may be at least half the spot diameter.

The laser, the metal surface, and the mark-facilitating layer may be selected such that the plume forms a mark on the mark-facilitating layer. This is particularly useful for making gold coloured marks on glass and other transparent materials from a plume ejected from a bare metal surface.

The method of the present invention may include the step of providing an apparatus for providing the mark-facilitating layer.

The invention also provides an article when marked according to the method of the invention. Examples of articles are mobile phones, tablet computers, watches, televisions, machinery, and jewellery.

The article may comprise the mark-facilitating layer.

The mark-facilitating layer may have been removed.

### BRIEF DESCRIPTION OF THE DRAWINGS

Embodiments of the invention will now be described solely by way of example and with reference to the accompanying drawings in which:

FIG. 1 shows apparatus for use in the method according to the present invention;

FIG. 2 shows a pulsed laser waveform;

FIG. 3 shows a laser beam that has been focussed onto a surface;

FIG. 4 shows a plume being ejected from an article without the mark-facilitating layer being present;

FIG. 5 shows the plume being retained by the mark-facilitating layer;

FIG. 6 shows the scanning velocity decelerating and accelerating between lines;

FIGS. 7 and 8 show a mark being made with different orientations of the mark;

FIG. 9 shows a mark formed in the transparent material;

FIG. 10 shows an apparatus for providing the mark-facilitating layer;

FIG. 11 shows a mark-facilitating layer that comprises a rigid layer and a compliant layer, which mark-facilitating layer is being pressed onto the metal surface with a force; and

FIG. 12 shows an article having a layer on the metal surface.

### DETAILED DESCRIPTION OF PREFERRED EMBODIMENTS OF THE INVENTION

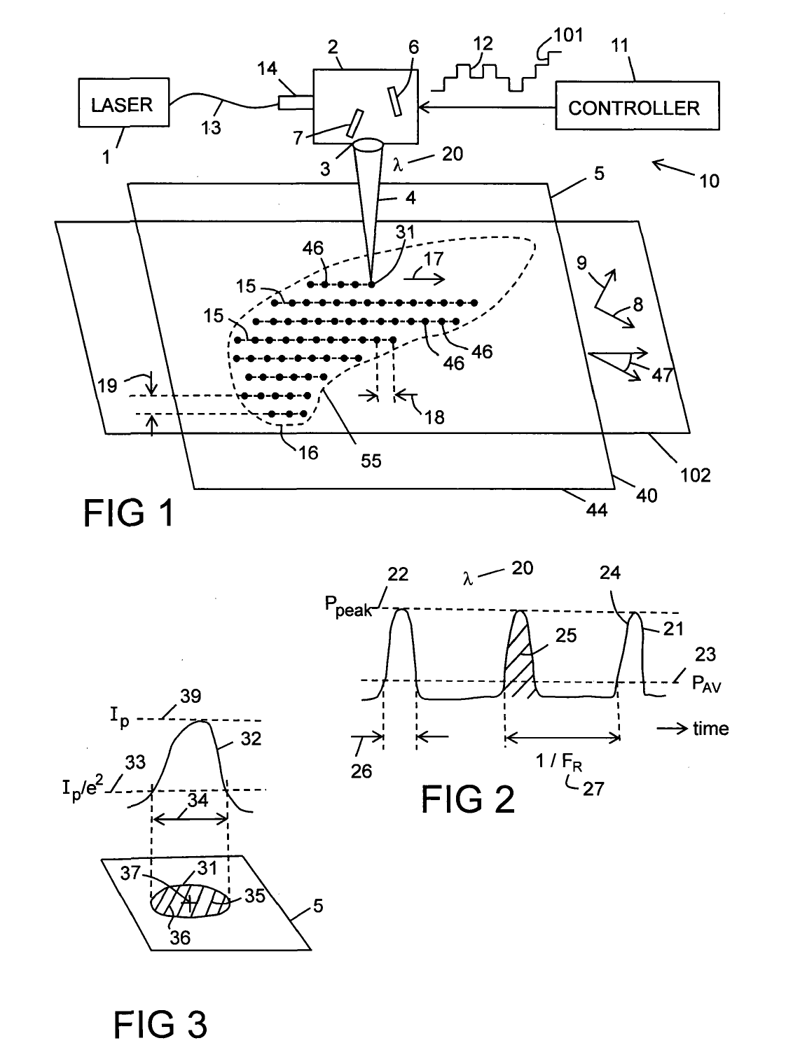

FIG. 1 shows a laser based marking machine 10 comprising a laser 1, a scanner 2, and an objective lens 3. A metal surface 5 is covered with a mark-facilitating layer 102 which is in contact with the metal surface 5. The scanner 2 moves a laser beam 4 having a wavelength 20 with respect to the metal surface 5. The scanner 2 comprises a first mirror 6 for moving the laser beam 4 in a first direction 8, and a second mirror 7 for scanning the laser beam 4 in a second direction 9. The scanner 2 is controlled by a controller 11 which controls the positions of the first and second mirrors 6, 7 by providing at least one control signal 12 to the scanner 2. The controller 11 may also control the laser 1. The first and the second mirrors 6, 7 would typically be attached to galvanometers (not shown).

The laser 1 can be a fibre laser, a solid state rod laser, a solid state disk laser, or a gas laser such as a carbon dioxide laser. For marking metal surfaces, the laser 1 is preferably a pulsed laser. The laser 1 is shown as being connected to the scanner 2 via an optical fibre cable 13 and collimation optics 14.

The control signal 12 is depicted as a digital control signal with finite resolution 101, which would typically be converted into an analogue signal either in the controller 11 or the scanner 2 using a digital to analogue converter. If the digital control signal is incremented slowly, that is, at time increments similar to or larger than the electrical and mechanical time constants in the scanner 2, then the finite resolution corresponds to finite angular resolution in the positions of the first and second mirrors 6, 7, and therefore finite spatial resolution in the position of the laser beam 4 on the metal surface 5. By filtering the control signal 12, either electronically, or by means of the inertia of the scanner 2 (for example the inertia of the first and second mirrors 6, 7 and associated galvanometers), improved angular resolution can typically be achieved in the scanner 2. This corresponds to improved spatial resolution in the position of the laser beam 4 on the metal surface 5.

Referring now to FIG. 2, there is shown a series of pulses 21. The series of pulses 21 may be obtained from the laser 1 wherein the laser 1 is a pulsed laser. The series of pulses 21 is characterized by a peak power 22, an average power 23, a pulse shape 24, a pulse energy 25, a pulse width 26, and a pulse repetition frequency F_{R}27.

FIG. 3 shows a spot 31 formed by focussing the laser beam 4 onto the metal surface 5. The optical intensity 32 is the power per unit area of the laser beam 4. The optical intensity 32 varies across the diameter of the spot 31 from a peak intensity 39 at its centre 37, to a 1/e² intensity 33 and to zero. The diameter 34 of the spot 31 is typically taken as the 1/e² diameter, which is the diameter at which the optical intensity 32 falls to the 1/e² intensity 33 on either side of the peak intensity 39. The area 35 of the spot 31 is typically taken as the cross-sectional area of the spot 31 within the 1/e² diameter 34. FIG. 3 shows the optical intensity 32 varying with a Gaussian or bell-shaped profile. The optical intensity 32 may have other profiles, including a top hat profile that is substantially uniform within the diameter 34.

Pulse fluence 36 is defined as the energy per unit area of the pulse 21. Pulse fluence is typically measured in J/cm², and is an important parameter for laser marking because a mark is typically formed when the pulse fluence 36 is sufficiently high that the laser beam 4 interacts with the metal surface 5.

A method according to the invention and for creating a mark 16 with a desired colour on an article 40 will now be described solely by way of example and with reference to FIG. 1. The article 40 comprises a metal 44 having a metal surface 5. The method comprises:
providing the laser 1 for emitting the laser beam 4 comprising the laser pulses 21 having the pulse energy 25, the pulse width 26, the pulse repetition frequency 27, and the wavelength 20 shown with reference to FIG. 2;
providing the scanner 2, which comprises the first mirror 6 for scanning the laser beam 4 in the first direction 8, and the second mirror 7 for scanning the laser beam 4 in the second direction 9;
providing the lens 3 for focussing the laser beam 4 from the laser 1 onto the metal surface 5 to form the spot 31 having the spot diameter 34 and the pulse fluence 36 shown with reference to FIG. 3;
providing the controller 11 for controlling the scanner 2 with the control signal 12;
marking a plurality of lines 15 separated by a hatch distance 19 on the metal surface 5 to form the mark 16 (shown in outline) by scanning the scanner 2 with a scan speed 17 while pulsing the laser 1; and
selecting the scan speed 17, the pulse repetition frequency 27, and the spot diameter 34 to provide a desired spot to spot separation 18 between the centres 37 of consecutive spots 31 during each scan of the scanner 2.

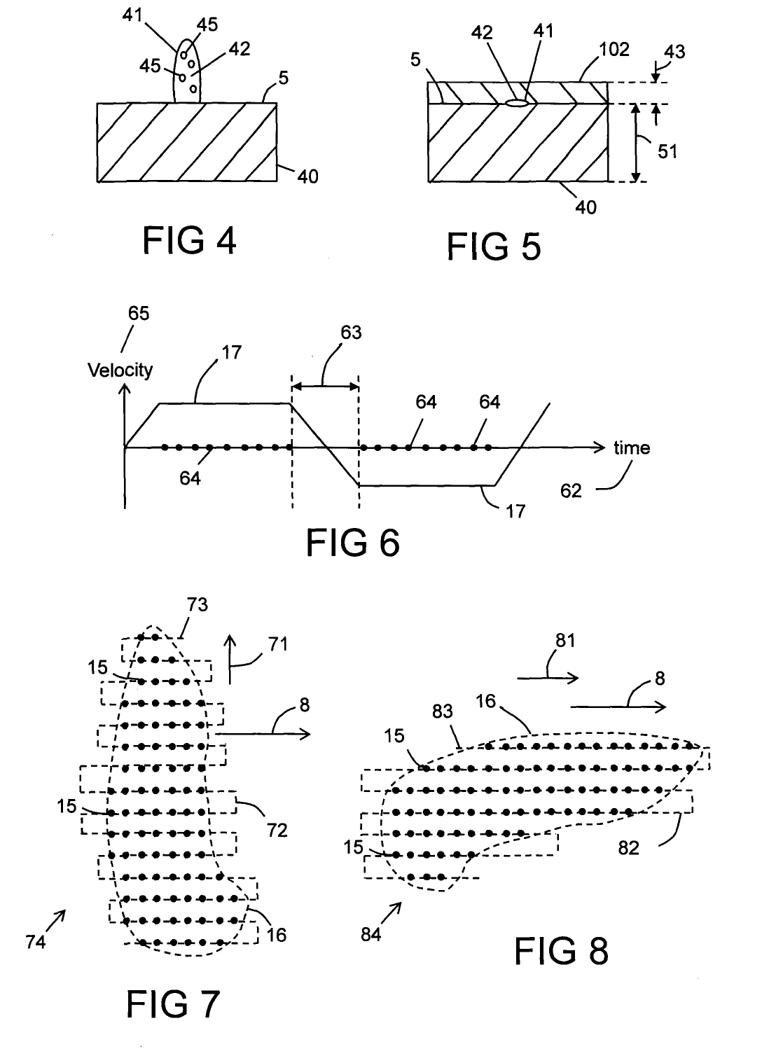

The method is characterized by:
causing the article 40 to be such that it has had a mark-facilitating layer 102 applied to the metal surface 5, which mark-facilitating layer 102 allows the laser pulses 21 to pass through the mark-facilitating layer 102 and strike the metal surface 5;
selecting the pulse fluence 36 to cause a plume 41, shown with reference to FIG. 4, comprising material 45 from the metal surface 5 to be ejected from the metal surface 5;
retaining at least a portion of the plume 41 with the mark-facilitating layer 102 in order to enable the plume 41 to mark the metal surface 5;
the colour being given by the spot to spot separation 18, the hatch distance 19, the pulse fluence 36, the pulse width 26, and the number of times each line 15 is written; and
selecting the spot to spot separation 18, the hatch distance 19, the pulse fluence 36, the pulse width 26, and the number of times each line 15 is written, to form the desired colour.

For clarity, the lines 15 are shown dashed with individual marks 46 formed by the laser pulses 21 shown separated from each other. In practice, the individual marks 46 will generally overlap each other. The lines 15 are shown as being written at an angle 47 to the first direction 8.

The method of the invention may include the steps of selecting the scan speed 17, the pulse repetition frequency 27, and the spot diameter 34 such that the spot to spot separation 18 between the centres 37 of consecutive spots 31 during each scan of the scanner 2 is at least a tenth of the spot diameter 34.

The mark-facilitating layer 102 is preferably in contact with the metal surface 5. The mark-facilitating layer 102 and the metal surface 5 may be forced together in order to create a sufficient contact. The force may be applied by gravity, by clamping, by stretching the mark-facilitating layer 102 over the metal surface 5, by surface tension, or by other means.

The spot to spot separation 18 between consecutive spots 31 during each scan of the scanner 2 may be at least one tenth of the spot diameter 34.

FIG. 4 shows an article 40 that comprises the metal surface 5 but without the mark-facilitating layer 102 being in place. The pulse fluence 36 can be selected to cause the plume 41 comprising the material 45 from the metal surface 5 to be ejected from the metal surface 5. The material 45 from the metal surface 5 is shown as being particles which may be nanoparticles. The particles may have changed their physical and chemical composition from the physical and chemical composition of the metal 44 of the metal surface 5. Alternatively or additionally, the plume 41 may include material 45 in the gas phase. The plume 41 has the recoil pressure 42 shown as being in the inside of the plume 41. The recoil pressure 42 causes the material 45 to be ejected from the metal surface 5 and in many materials such as bare aluminium, silver and gold, a mark is not formed.

By placing the mark-facilitating layer 102 in contact with the metal surface 5, as shown in FIG. 5, the plume 41 can be prevented from dissipating if the contact of the mark-facilitating layer 102 with the metal surface 5 is sufficient to retain at least a portion of the recoil pressure 42 of the plume 41. The plume 41 and the recoil pressure 42 are then retained by the contact between the metal surface 5 and the mark-facilitating layer 102, enabling one of the individual marks 46 shown with reference to FIG. 1 to be formed. The formation of the individual marks 46 may be assisted by heat within the plume 41. It may be necessary to increase the pulse fluence 36 to compensate for optical attenuation of the laser beam 4 by the mark-facilitating layer 102 in order to form the plume 41 when the mark-facilitating layer 102 is used. The mark-facilitating layer 102 is shown as having a thickness 43. The article is shown as having a thickness 51.

The method of the invention is able to produce black and dark grey marks on metals without the need for permanent additives. The method of the invention is able to produce marks on metals that are darker when compared to marks produced with the same pulse fluence 36 but without the mark-facilitating layer 102. In particular, the method is able to produce coloured marks on a bare metal surface of a metal 44 such as copper, aluminium, gold, silver, platinum, palladium, nickel, titanium, tin, iron, chromium, stainless steel or an alloy containing one of the preceding metals such as bronze or brass. Marks that are formed on bare aluminium, gold or silver without the mark-facilitating layer 102 are engraved, which affects the surface roughness, or have a modified surface texture, which does not affect the colour of the metal surface 5.

Referring to FIG. 1, the method may include the step of selecting the spot to spot separation 18, the hatch distance 19, the pulse fluence 36, the pulse width 26, and the number of times each line 15 is written such that the mark 16 has a surface roughness average Ra value 55 less than or equal to fifty microns, less than twenty microns, or less than five microns. The ability to produce marks, without the use of inks or chemicals, on bare metal surfaces that are smooth is a particularly advantageous aspect of the method of the invention which has important commercial advantages in the manufacture of jewellery and consumer products which often have polished metal surfaces.

FIG. 12 shows an article 40 in which the metal surface 5 comprises a layer 121 on its surface. The layer 121 is not the mark-facilitating layer 102 of FIG. 1. The layer 121 can be a metallic coating. Metal packaging for high power electronic or optoelectronic devices are often made from metals such as copper which are coated with a very thin coating of gold in order to improve thermal emissivity. The layer 121 can be a non-metallic layer. The non-metallic layer can be an oxide layer. “Bare aluminium” that has not been anodized, typically has an oxide layer on its surface. The metal surface 5 can be a non-anodized metal surface.

Referring again to FIG. 1, the metal surface 5 can comprise copper, aluminium, gold, silver, platinum, palladium, nickel, titanium, tin, iron, chromium, stainless steel or an alloy containing one of the preceding metals such as bronze or brass.

The mark-facilitating layer 102 can be glass. High quality marks have been made on various metal surfaces using glass microscope slides and glass microscope covers as the mark-facilitating layer 102. The glass microscope slides were approximately 2 mm thick, and the glass microscope covers were approximately 100 μm thick.

The mark-facilitating layer 102 may be sapphire. Sapphire is an important material in consumer electronics.

The mark-facilitating layer 102 may be a lacquer. Lacquers are often applied to beverage cans and other consumer products. Being able to make a mark through the lacquer without destroying the lacquer has important commercial advantages.

The mark-facilitating layer 102 may be a conformal coating. The conformal coating may comprise polyimide.

The mark-facilitating layer 102 may be a sheet material such as a polymer. The sheet material may be stretched over the metal surface 6 prior to laser marking. The sheet material can be removed after laser marking.

The mark-facilitating layer 102 may be an adhesive-backed tape. The adhesive-backed tape may comprise cellophane. The adhesive-backed tape may comprise a high temperature polymer. High temperature polymers can survive temperatures greater than 500 C, preferably greater than 750 C, and more preferably 1000 C. Adhesive-backed tapes are available from Polyonics of New Hampshire, United States of America. The high temperature polymer may comprise acrylic. The high temperature polymer may comprise silicone. The high temperature polymer may comprise polyimide. The high temperature polymer may comprise polyester. The high temperature polymer may be halogen free. Adhesive-backed tapes are particularly advantageous as they can be applied to the surface simply, and are easily removed after marking.

The thickness 43 of the mark-facilitating layer 102 may be greater than 1 μm. The thickness 43 may be between 50 μm and 3 mm.

The method of the invention may include the step of removing the mark-facilitating layer 102 after the mark 16 has been formed. For example, if the mark-facilitating layer 102 is glass, the glass can be simply removed. If the mark-facilitating layer 102 is a lacquer, then it can be removed by chemical processing. The chemical processing may be immersion in a solvent such as acetone. Acetone can dissolve lacquers.

The mark-facilitating layer 102 may have an optical transmission at the wavelength 20 of the laser beam 4 of at least 50%. The optical transmission may be at least 80%. The optical transmission is preferably at least 90%.

Experiments have demonstrated the quality and blackness of the marks, and the improvement in writing the mark 16 according to the method of the invention, particularly when writing marks on bare metal surfaces such as aluminium and silver.

A range of mark-facilitating layers 102 have been tested including glass, polyethylene and clear lacquer and each produced a black mark on the metal surface 5. Rigid and flexible mark-facilitating layers have been successfully tested. The mark-facilitating layer 102 may be supported by the metal surface 5. The mark-facilitating layer 102 may not be permanently attached to the metal surface 5 and may be removed after forming the mark 16.

The colour of the mark 16 may be grey or black. The colour, as quantified by the International Commission on Illumination CIE system, may have an L* value less than or equal to 50. Preferably the L* value is no greater than 30. A mark having an L* value less than or equal to 30 is generally considered to be a black mark. A black mark having near perfect finishes that can be written rapidly onto consumer goods is commercially very important. Indeed the speed of writing and the quality of the mark 16 can make the difference between the mark 16, and the laser based marking machine 10 for making the mark 16, being commercially viable or non-viable.

The laser 1 may be a pulsed laser having a pulse width 26 greater than one hundred picoseconds. The pulse width 26 may be greater than 1 nanosecond. It is surprising and commercially significant that high quality black marks can be made rapidly, and with nanosecond pulsed lasers as opposed to picosecond pulsed lasers that have pulse widths less than approximately 10 ps to 50 ps. This is because nanosecond pulsed lasers are by their very nature lower cost than picosecond lasers, and are much lower cost than femtosecond and picosecond pulsed lasers that have pulse widths less than approximately 50 ps and are which marketed for cold laser processing applications such as cold ablation. Such lasers rely on pulse compression techniques or incorporate pulse compressors. It is preferred that the laser 1 does not include a pulse compressor.

The laser 1 may be an optical fibre laser having a single mode or a multi mode rare-earth doped fibre. The laser beam 4 may have a beam quality defined by an M² value less than 6, preferably less than 4, and more preferably less than 1.3.

The wavelength 20 is preferably in the range 1000 nm to 1100 nm. Such wavelengths are emitted by ytterbium-doped fibre lasers.

The scanning by scan mirrors 6 and 7 may be accelerated prior to pulsing the laser 1 as shown with reference to FIG. 6, which shows the velocity 65 of the laser beam 4 with respect to the metal surface 6 as a function of time 62. Accelerating the scanning by scan mirrors 6, 7 reduces edge effects on the mark 16 by ensuring that the laser beam 4 is moving at the desired scanning speed 17 with respect to the metal surface 6 prior to the laser 1 emitting the pulses 64. A time interval 63 is shown during which the scan is decelerated, and then accelerated in the opposite direction, the velocity 65 being inverted prior to the laser 1 emitting additional pulses 64.

As shown with reference to FIGS. 7 and 8, the metal surface 5 may be orientated to minimize the overall time taken to form the mark 16. The mark 16 is orientated in direction 71 in FIG. 7, marked along trajectory 72 that has a total length 73 and a total number 74 of lines 15. The mark 16 is orientated in direction 81 in FIG. 8, marked along trajectory 82 that has a total length 83 and a total number 84 of lines 15. The overall time taken to produce the mark 16 is related to the overall distance 73, 83 by the scanning speed 17 and the time 63 required to accelerate and decelerate at the beginning and end of each line 15. As can be seen by inspecting FIGS. 7 and 8, the mark 16 can be made more quickly with the orientation 81 of FIG. 8 than the orientation 71 of FIG. 7 because the total number 84 of lines 15 is less than the total number of lines 74, and consequently, less time 63 required for decelerating and accelerating. The lines 15 can each be scanned a plurality of times.

Referring to FIG. 6, the scanning speed 17 may be at least 1 m/s. The scanning speed 17 may be at least 5 m/s.

Referring to FIG. 2, the pulse repetition frequency 27 may be at least 100 kHz. The pulse repetition frequency 27 may be at least 500 kHz.

The scanning speed 17 may be at least 9 m/s, and the pulse repetition frequency 27 may be at least 900 kHz.

Each line 15 may be written more than once. Preferably, each line is written at least 5 times, but more or less times may be employed. Although it is possible to scan each line 15 only once with the same pulse repetition frequency 27, it has been found that thermal damage can occur on the metal surface 5. It is therefore preferred to write each line 15 as rapidly as possible in order to minimize thermal damage and thus optimize the quality of the mark 16. The spacing 19 between successive lines, referred to as the hatch distance, may be less than the spot diameter 34, preferably less than a tenth of the spot diameter 34 or more preferably less than a hundredth of the spot diameter 34. The angle 47 of the lines 15 of successive repeats can be varied in the range 0° to 359°. The mark-facilitating layer 102 may be replaced between successive repeats.

Referring to FIG. 1, the spot to spot separation 18 (measured from the centres 37 of the spots 31) may be at least a quarter of the spot diameter 34 shown with reference to FIG. 3. The spot to spot separation 18 may be at least half the spot diameter 34. The separation 18 may be uniform, may vary along the line 15, or may be different in different lines 15. When overwriting the lines 15, the separation 18 may be the same in each scan, or different.

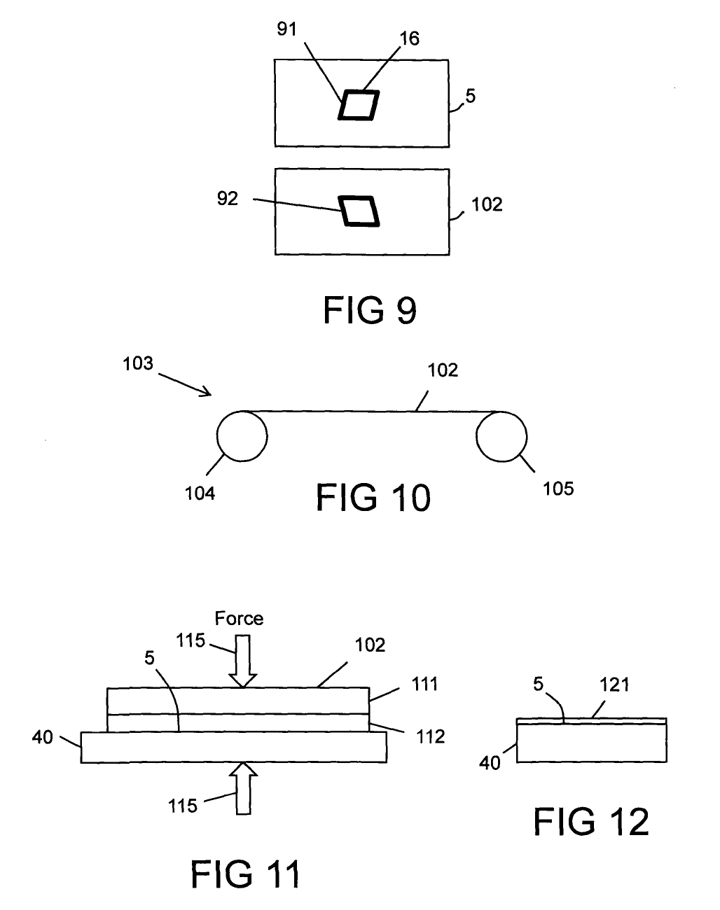

As shown in FIG. 9, the method of the invention can be used to form a mark 92 on the mark-facilitating layer 102. In FIG. 9, the mark-facilitating layer 102 has been lifted off the metal surface 5 and rotated through 180 degrees. The mark 16 on the metal surface 5 is a logo 91. The corresponding mark 92 on the transparent surface 102 is also a logo, but one which is the mirror image of the logo 91. It is possible to obtain various coloured marks 92 on mark-facilitating layers 102 comprising glass. Coloured marks 92 that are coloured black or brown have been obtained when the metal surface 5 was aluminium. Coloured marks 92 that are coloured black when viewed directly, and coloured gold when viewed through the mark-facilitating layer have been obtained when the metal surface 5 was silver. Other colours are also obtainable. The laser 1, the metal surface 5, the mark-facilitating layer 102 are selected such the plume 41 shown with reference to FIGS. 4 and 5 forms the mark 92 on the mark-facilitating layer 102.

The method described with respect to FIGS. 1 to 9 may include the step of providing an apparatus 103, such as shown with reference to FIG. 10, for providing the mark-facilitating layer 102. The laser based marking machine 10 of FIG. 1 may include the apparatus 103. The apparatus 103 shown in FIG. 10 comprises a dispensing reel 104, and a take up reel 105, such that the mark-facilitating layer 102 can be reeled from the dispensing reel 104 to the take up reel 105. This apparatus is convenient if the mark-facilitating layer 102 is in the form of a flexible sheet of material such as a foil, a polymer film, or an adhesive-backed tape. If the mark-facilitating layer 102 is a rigid material, such as glass, then the apparatus 103 can be similar to a slide cassette dispenser. Alternatively or additionally, the apparatus 103 may contain a wheel for rotating the mark-facilitating layer 102 such that different parts of the mark-facilitating layer 102 can be used to mark one or more articles 40 at different times.

Referring again to FIG. 1, the method of the invention can include the step of pressing the mark-facilitating layer 102 onto the metal surface 5 with a force 115, shown with respect to FIG. 11, that provides sufficient contact to be made for the mark 16 to be written in the desired colour. The force 115 required can be determined through experimentation. The laser writing process can also be repeated on the same mark 16 after replacing the mark-facilitating layer 102. The mark-facilitating layer 102 described with reference to FIGS. 1 to 10 can comprise a rigid layer 111 and a compliant layer 112 as shown with respect to FIG. 11. The compliant layer 112 is particularly useful when marking rough surfaces where it is difficult to obtain sufficient contact with a rigid layer such as glass. The rigid layer 111 can be a glass slide. The compliant layer 112 can be a polymer that has a compliance that is greater than a compliance of the rigid layer 111.

The method of the present invention as described above with reference to FIGS. 1-11 is particularly attractive because it is able to produce marks on metal surfaces faster, and therefore, more economically than has hitherto been possible, without the need for inks, dyes or other chemicals. For example, a black mark could be obtained on bare aluminium with lines that are written only once, with spot to spot separations of approximately 10 μm and a hatch distance 19 of approximately 0.2 μm. However, considerable time will be spent between scans when using a typical scanner with a digital resolution 101 corresponding to 2 μm as a relatively complicated waveform needs to be derived to control the scanner to achieve a sub-digital resolution 12 of 0.2 μm. Surprisingly, however, the method of the present invention is able to achieve significant increases in processing speeds by stepping the scanner by 2 μm (its digital resolution), and overwriting the lines ten times (equal to the quotient of 2 μm and 0.2 μm). Also surprisingly, the method of the present invention is able to provide better uniformity of the mark 16 by overwriting each line 15 at least once, than by writing each line 15 only once but with a smaller hatch distance 19. The better uniformity can be seen by the naked eye.

The second mirror 7 may be characterized by a digital resolution 101 shown with reference to FIG. 1. Preferably the hatch distance 19 corresponds to an integral multiple of the digital resolution 101. For example, a typical scanner may have a digital resolution 101 corresponding to a hatch distance 19 of 2 μm (typically the product of the angular digital resolution measured in radians and the focal length of the lens 3). Instead of writing ten individual lines 15 with a hatch distance 19 of 0. 2 μm, it has been discovered that marks of the same or similar quality can be written by writing each line 15 ten times using a hatch distance 19 of 2 μm. Not only is this surprising, but it provides a means of significantly reducing the time taken to mark an object. This is because of the removal of superfluous timing delays as the first scanning mirror 6 scans over the same path. The proportion of time taken for typical controllers to increment the hatch distance 19 between successive lines 15 can be significant, particularly when demanding sub-digital resolution.

The laser 1 can be a fibre laser, a disk laser, a rod laser, or another form of solid state laser.

The pulse fluence 36 can be in the range 0.02 J/cm² to 10 J/cm². Preferably the pulse fluence 36 is in the range 0.3 J/cm² to 5 J/cm². More preferably the pulse fluence 36 is in the range 0.5 J/cm² to 2 J/cm².

The pulse width 26 can be in the range 100 ps to 250 ns. Preferably the pulse width 26 is in the range 300 ps to 10 ns. More preferably the pulsed width 26 is in the range 500 ps to 5 ns.

The peak power 22 is preferably greater than 1 kW.

The scanning speed 17 can be at least 1 m/s. The scanning speed 17 is typically in the range 1 to 25 m/s. Preferably the scanning speed 17 is in the range 5 to 15 m/s. More preferably the scanning speed 17 is the range 7 to 10 m/s.

The pulse repetition frequency 27 may be at least 1 kHz, preferably at least 25 kHz and more preferably at least 500 kHz.

Preferably, each line 15 is written by scanning the first mirror 6 while holding the second mirror 7 stationary. Preferably, the hatch distance 19 is achieved by moving the second mirror 7. This is advantageous because it reduces delays in setting up the control parameters in the controller 11.

The pulse repetition frequency 27 may be at least 500 kHz.

The scan speed 17 may be at least 9 m/s, and the pulse repetition frequency 27 may be at least 900 kHz. Such a combination of scan speed 17 and pulse repetition frequency 27 is equivalent to a spot to spot separation 18 of 10 μm. This is typically around half the diameter 34 of the spot 31 that is readily achievable on the metal surface 5 when using a single-mode pulsed fibre laser.

The method described above may be used to mark a wide variety of articles including, for example, mobile phones, tablet computers, watches, televisions, machinery, and jewellery.

The method of the invention will now be described with reference to the following non-limiting examples, which are given for illustrative purposes only.

In the following examples, the laser 1 shown with reference to FIG. 1 was a pulsed fibre laser model number SP-020P-A-EP-S-A-Y, manufactured by SPI Lasers UK Ltd of Southampton, England. The laser is a ytterbium doped fibre laser that is configured as a master oscillator power amplifier. The scanner 2 was a galvanometric scan-head model SuperScan II, manufactured by Raylase GmbH of Wessling Germany. The objective lens 3 was a 163 mm focal length f-theta objective lens. The laser beam 4 was delivered from the laser 1 to the scanner 2 via a 75 mm beam expanding collimator (BEC) 14 which enabled the laser beam 4 to have a nominal diameter of 7.5 mm (1/e²) at the entrance to the scanner 2, and a spot diameter 34 of 34 μm +/−5.0 μm to be generated at the focal plane of the scanner objective lens 3.

Referring to FIGS. 1 to 3, the laser 1 was capable of generating having pulse widths 26 between approximately 3 ns to approximately 500 ns, and was operated over a range of average output power 23, pulse repetition frequency 27, and temporal pulse shape 24. The pulse energy 25 and pulse peak power 22 were repeatable, and could be accurately controlled. The scanner 2 was able to scan the laser beam 4 with a scan speed 17 of up to 10 m/s. The scan speed 17 was able to be accurately controlled so that when the laser 1 was operating at a known pulse repetition frequency 27, the number of laser pulses per unit length of movement, and hence the spot to spot separation 18, could be calculated.

### EXAMPLE 1

With reference to FIG. 5, the article 40 was a sheet of aluminium grade 5251 with a thickness 51 of 1 mm. The aluminium would be typically referred to as “bare aluminium” although it will have an oxide layer on its surface. The mark-facilitating layer 102 was a glass microscope slide with a thickness 43 of 1 mm. The microscope slide was clamped onto the aluminium sheet so that there was no visible gap between them. Focus was determined such that the laser beam 4 was focused onto the metal surface 5. The laser beam 4 was repetitively pulsed at the pulse repetition frequency 27 of 600 kHz and scanned over the metal surface 5 at a speed of 6000 mm/s using a hatch spacing of 0.5 μm. The pulse width 26 was 3 ns at full width half maximum and the pulse energy was 12 μJ. The pulse fluence 36 was 1.3 J/cm². The resulting mark 16 was dark gray with an L* value of approximately 35. It was not possible to remove the mark 16 by wiping with solvent. Importantly, it was not possible to make a dark mark using the same apparatus without the use of the mark-facilitating layer 102.

### EXAMPLE 2

With reference to FIG. 5, the article 40 was a sheet of aluminium grade 5251 with a thickness 51 of 1 mm. The aluminium would be typically referred to as “bare aluminium” although it will have an oxide layer on its surface. The mark-facilitating layer 102 was a polyethylene sheet with a thickness 43 of 75 μm. The plastic sheet was clamped onto the aluminium sheet so that there was no visible gap between them. Focus was determined such that the laser beam 4 was focused onto the metal surface 5. The laser beam 4 was repetitively pulsed at the pulse repetition frequency 27 of 600 kHz and scanned over the metal surface 5 at a speed of 6000 mm/s using a hatch spacing of 0.5 μm. The pulse width 26 was 3 ns at full width half maximum and the pulse energy was 12 μJ. The pulse fluence 36 was 1.3 J/cm². The resulting mark 16 was dark gray with an L* value of approximately 35. It was not possible to remove the mark 16 by wiping with solvent. Importantly, it was not possible to make a dark mark using the same apparatus without the use of the mark-facilitating layer 102.

### EXAMPLE 3

With reference to FIG. 5, the article 40 was a sheet of copper with a thickness 51 of 2 mm with a thin coating of gold typically 1 μm thick. The mark-facilitating layer 102 was a glass sheet with a thickness 43 of 1 mm. The glass sheet was clamped onto the gold-coated copper sheet so that there was no visible gap between them. The focal length of the collimating optic 14 was 100 mm, the 1/e² beam diameter at the entrance to the scanner was 11 mm, the focal length of the objective lens 3 was 160 mm and the 1/e² focal spot diameter 34 was 27 μm +/−5 μm. Focus was determined such that the laser beam 4 was focused onto the metal surface 5. The laser beam 4 was repetitively pulsed at the pulse repetition frequency 27 of 600 kHz and scanned over the metal surface 5 at a speed of 6000 mm/s using a hatch spacing of 0.5 μm. The pulse width 26 was 3 ns at full width half maximum and the pulse energy was 20 μJ. The pulse fluence 36 was 1.6 J/cm². The resulting mark 16 was black with an L* value of approximately 25. It was not possible to remove the mark 16 by wiping with solvent. Importantly, it was not possible to make a dark mark using the same apparatus without the use of the mark-facilitating layer 102.

### EXAMPLE 4

With reference to FIG. 5, the article 40 was a sheet of brass grade CW508L with a thickness 51 of 1 mm. The mark-facilitating layer 102 was a glass microscope slide with a thickness 43 of 1 mm. The microscope slide was clamped onto the brass sheet so that there was no visible gap between them. Focus was determined such that the laser beam 4 was focused onto the metal surface 5. The laser beam 4 was repetitively pulsed at the pulse repetition frequency 27 of 600 kHz and scanned over the metal surface 5 at a speed of 6000 mm/s using a hatch spacing of 0.5 μm. The pulse width 26 was 3 ns at full width half maximum and the pulse energy was 12 μJ. The pulse fluence 36 was 1.3 J/cm². The resulting mark 16 was black with an L* value of approximately 20. It was not possible to remove the mark 16 by wiping with solvent. Importantly, it was not possible to make a dark mark using the same apparatus without the use of the mark-facilitating layer 102.

### EXAMPLE 5

With reference to FIG. 5, the article 40 was a sheet of non-anodized aluminium with a thickness 51 of 0.2 mm. The mark-facilitating layer 102 was a clear lacquer coating with a nominal thickness 43 of 50 μm. Focus was determined such that the laser beam 4 was focused onto the metal surface 5. The laser beam 4 was repetitively pulsed at the pulse repetition frequency 27 of 600 kHz and scanned over the metal surface 5 at a speed of 6000 mm/s using a hatch spacing of 0.5 μm. The pulse width 26 was 3 ns at full width half maximum and the pulse energy was 12 μJ. The pulse fluence 36 was 1.3 J/cm². The resulting mark 16 was black with an L* value of approximately 20. It was not possible to remove the mark 16 by wiping with solvent. Importantly, it was not possible to make a dark mark using the same apparatus without the use of the mark-facilitating layer 102.

### EXAMPLE 6

With reference to FIG. 5, the article 40 was a sheet of sterling silver with a thickness 51 of 0.5 mm. The mark-facilitating layer 102 was a glass microscope slide with a thickness 43 of 1 mm. The microscope slide was clamped onto the silver sheet so that there was no visible gap between them. Focus was determined such that the laser beam 4 was focused onto the metal surface 5. The laser beam 4 was repetitively pulsed at the pulse repetition frequency 27 of 600 kHz and scanned over the metal surface 5 at a speed of 6000 mm/s using a hatch spacing of 0.5 μm. The pulse width 26 was 3 ns at full width half maximum and the pulse energy was 12 μJ. The pulse fluence 36 was 1.3 J/cm². The resulting mark 16 on the silver sheet was dark grey with an L* value of approximately 40. The mark 92 (shown with reference to FIG. 9) on the glass microscope slide was dark grey in some areas and black in other areas when viewed directly, and a uniform gold colour when viewed through the glass. It was not possible to remove either the mark 16 or the mark 92 by wiping with solvent. Importantly, it was not possible to make a dark mark using the same apparatus without the use of the mark-facilitating layer 102.

With reference to the Examples above, it is believed that darker marks would be obtainable by doing one or more of adjusting the pulse fluence 36, the spot to spot spacing 18, the line to line spacing 19, by increasing the contact pressure between the mark-facilitating layer 102 and the metal surface 5, or by overwriting the mark 16, preferably using lines 15 written at different angles 47.

It is to be appreciated that the embodiments of the invention described above with reference to the accompanying drawings have been given by way of example only and that modifications and additional steps and components may be provided to enhance performance. Individual components shown in the drawings are not limited to use in their drawings and may be used in other drawings and in all aspects of the invention. The present invention extends to the above mentioned features taken singly or in any combination.

1. A method for creating a mark with a desired colour on an article, wherein the article comprises a metal having a metal surface, and which method comprises:
providing a laser for emitting a laser beam comprising laser pulses having a pulse energy, a pulse width, a pulse repetition frequency, and a wavelength;
providing a scanner comprising a first mirror for scanning the laser beam in a first direction, and a second mirror for scanning the laser beam in a second direction;
providing a lens for focussing the laser beam from the laser onto the metal surface to form a spot having a spot diameter and a pulse fluence;
providing a controller for controlling the scanner with a control signal;
marking a plurality of lines separated by a hatch distance on the metal surface to form the mark by scanning the scanner while pulsing the laser; and
selecting a scan speed, the pulse repetition frequency, and the spot diameter to provide a desired spot to spot separation between the centres of consecutive spots during each scan of the scanner;
the method being characterized by:
prior to marking with the laser the article has a mark-facilitating layer applied to the metal surface, which mark-facilitating layer allows the laser pulses to pass through the mark-facilitating layer and strike the metal surface;
selecting the pulse fluence to cause a plume comprising material from the metal surface to be ejected from the metal surface,
retaining at least a portion of the plume with the mask-facilitating layer in contact with the metal surface in order to enable the plume to mark the metal surface;
the colour being given by the spot to spot separation, the hatch distance, the pulse fluence, the pulse width, and the number of times each line is written; and
selecting the spot to spot separation, the hatch distance, the pulse fluence, the pulse width, and the number of times each line is written to form the desired colour; and
wherein the metal surface is a non-anodized metal surface.

2.-7. (canceled)

8. A method according to claim 1 wherein the plume has a recoil pressure, and the mark-facilitating layer has a contact with the metal surface, which contact is sufficient to retain at least a portion of the recoil pressure of the plume.

9. A method according to claim 1 and including the step of selecting the spot to spot separation, the hatch distance, the pulse fluence, the pulse width, and the number of times each line is written such that the mark has a surface roughness average Ra value less than or equal to fifty microns.

10.-11. (canceled)

12. A method according to claim 1 wherein the metal surface comprises a bare metal surface.

13. A method according to claim 1 wherein the metal surface comprises an additional layer.

14.-16. (canceled)

17. A method according to claim 1 mg-el-aims wherein the metal surface comprises copper, aluminium, gold, silver, platinum, palladium, nickel, titanium, tin, iron, chromium, stainless steel or an alloy comprising one of the preceding metals.

18. A method according to claim 1 wherein the mark-facilitating layer comprises glass, sapphire, a lacquer. a conformal coating, a sheet material, a polymer, or an adhesive backed tape.

19.-26. (canceled)

27. method according to claim 1 wherein the method includes the step of removing the mark-facilitating layer.

28.-31. (canceled)

32. A method according to claim 1 wherein the colour is grey or black with an L* value no greater than 50.

33. A method according to claim 32 wherein the value is no greater than 30.

34. A method according to claim 1 wherein the laser is a pulsed laser providing a laser beam having a pulse width greater than one hundred picoseconds.

35. A method according to claim 34 wherein the pulse width is greater than 1 nanosecond.

36. A method according to claim 1 wherein the wavelength is in the range 1000 nm to 1100 nm.

37.-41. (canceled)

42. A method according to claim 1 wherein the pulse repetition frequency is at least 500 kHz.

43. (canceled)

44. A method according to claim 1 wherein each line is written more than once.

45. A method according to claim 1 wherein the laser, the metal surface, and the mark-facilitating layer are selected such that the plume forms a mark on the mark-facilitating layer.

46. A method according to claim 1 and including the step of providing an apparatus for providing the mark-facilitating layer.

47. An article when marked according to the method claimed in claim 1, wherein the metal surface is a bare metal surface, the colour of the mark is grey or black with an L* value no greater than 50, the mark comprises material from the metal surface.

48. An article according to claim 47 and comprising the mark-facilitating layer.

49. An article according to claim 47 wherein the mark-facilitating layer has been removed.
